(19) United States
(12) Patent Application Publication
(10) Pub. No.: US 2026/0000557 A1
(43) Pub. Date: Jan. 1, 2026

(54) CONNECTION SYSTEM FOR MEDICAL BED COMPONENTS

(71) Applicant: Sizewise Rentals, LLC, Lenexa, KS (US)

(72) Inventors: Troy Parson, Ellis, TX (US); Matthew Ray Isley, Hays, KS (US)

(73) Assignee: Sizewise Rentals, LLC, Lenexa, KS (US)

(21) Appl. No.: 19/255,518

(22) Filed: Jun. 30, 2025

Related U.S. Application Data
(60) Provisional application No. 63/665,893, filed on Jun. 28, 2024.

(51) Int. Cl. A61G 7/05; F16B 5/06

(52) U.S. Cl. CPC A61G 7/0508; A61G 7/0506; F16B 5/0614

(57) ABSTRACT

A connection system may include a first receiver and second receiver extending through a first surface, wherein the first receiver comprises a first pin aligned with a first central axis of the first receiver. A second component having a second surface may be configured to abut the first surface, the second component comprising: a first support post extending outwardly from the second surface, wherein the first support post comprises a first distal end and a recess extending through the first distal end; and a second support post extending outwardly from the second surface, wherein the first support post is approximately parallel to the second support post, wherein the first receiver is configured to couple with the first support post when the first pin is at least partially inserted into the recess, and wherein the second receiver is configured to couple with the second support post.

### CROSS REFERENCE TO RELATED APPLICATIONS

This U.S. non-provisional patent application claims priority to U.S. Provisional Patent Application No. 63/665,893, filed Jun. 28, 2024. The contents of the identified earlier-filed application are hereby incorporated by reference into the present application.

### FIELD OF THE DISCLOSED SUBJECT MATTER

The disclosed subject matter generally relates to a connection system for medical bed components, and more particularly, but not necessarily exclusively, a connection system for medical bed components comprising a pair of posts and a pair of receivers.

### SUMMARY

In some aspects, the disclosed subject matter described herein relates to a connection system including: a first component having a first surface, the first component including: a first receiver extending through the first surface, wherein the first receiver includes a first pin aligned with a first central axis of the first receiver; and a second receiver extending through the first surface; and a second component having a second surface configured to abut the first surface, the second component including: a first support post connected to and extending outwardly from the second surface, wherein the first support post includes a first distal end and a first recess extending through the first distal end; and a second support post connected to and extending outwardly from the second surface, wherein the first support post is approximately parallel to the second support post; wherein the first receiver is configured to couple with the first support post when the first pin is at least partially inserted into the first recess, and wherein the second receiver is configured to couple with the second support post, thereby connecting the first component to the second component.

In some aspects, the disclosed subject matter described herein relates to a connection system, wherein the first component includes a patient support assembly of a medical bed.

In some aspects, the disclosed subject matter described herein relates to a connection system, wherein the second component includes one of a headboard, a footboard, and a side rail.

In some aspects, the disclosed subject matter described herein relates to a connection system, wherein the first support post includes a hollow cylinder.

In some aspects, the disclosed subject matter described herein relates to a connection system, wherein the first recess includes a first cylindrical sleeve configured to couple with the hollow cylinder.

In some aspects, the disclosed subject matter described herein relates to a connection system, wherein the second support post includes a solid cylinder.

In some aspects, the disclosed subject matter described herein relates to a connection system, wherein the second recess includes a second cylindrical sleeve configured to couple with the second support post.

In some aspects, the disclosed subject matter described herein relates to a connection system, wherein the first surface is configured to at least partially abut the second surface.

In some aspects, the disclosed subject matter described herein relates to a connection system, wherein the first pin is connected to the first component via a bracket.

In some aspects, the disclosed subject matter described herein relates to a connection system including: a medical bed having an upper frame, the upper frame including: a first receiver extending through the upper frame, wherein the first receiver includes a first pin aligned with a first central axis of the first receiver; and a second receiver extending through the upper frame; and a second component having a second surface configured to abut the upper frame, the second component including: a first support post connected to and extending outwardly from the second surface, wherein the first support post includes a first distal end and a first recess extending through the first distal end; and a second support post connected to and extending outwardly from the second surface, wherein the first support post is approximately parallel to the second support post; wherein the first receiver is configured to couple with the first support post when the first pin is at least partially inserted into the first recess, and wherein the second receiver is configured to couple with the second support post, thereby connecting the upper frame to the second component.

In some aspects, the disclosed subject matter described herein relates to a connection system, wherein the second component includes one of a headboard, a footboard, and a side rail.

In some aspects, the disclosed subject matter described herein relates to a connection system, wherein the first support post includes a hollow cylinder.

In some aspects, the disclosed subject matter described herein relates to a connection system, wherein the first recess includes a first cylindrical sleeve configured to couple with the hollow cylinder.

In some aspects, the disclosed subject matter described herein relates to a connection system, wherein the second support post includes a solid cylinder.

In some aspects, the disclosed subject matter described herein relates to a connection system, wherein the second receiver includes a second cylindrical sleeve configured to couple with the second support post.

In some aspects, the disclosed subject matter described herein relates to a connection system, wherein the upper frame is configured to at least partially abut the second surface.

In some aspects, the disclosed subject matter described herein relates to a connection system, wherein the first pin is connected to the upper frame via a bracket.

In some aspects, the disclosed subject matter described herein relates to a method for connecting a component to a medical bed including the steps of: providing a medical bed having an upper frame, a first receiver, and a second receiver, wherein the first receiver includes a pin positioned along a central axis of the first receiver; providing a component having a first support post and second support post, wherein the first support post includes a first recess extending at least partially through first support post; inserting the first support post at least partially into the first receiver, whereby the pin is at least partially inserted into the first recess; and inserting the second support post at least partially into the second receiver, thereby connecting the component to the medical bed in a preferred orientation relative to the upper frame.

In some aspects, the disclosed subject matter described herein relates to a method, wherein the component includes one of a headboard, a footboard, and a side rail.

In some aspects, the disclosed subject matter described herein relates to a method, wherein the first support post is approximately parallel with the second support post.

### BRIEF DESCRIPTION OF THE DRAWINGS

The detailed description particularly refers to the accompanying figures, in which:

FIG. 1 is a perspective view of a medical bed and a component in a connected configuration in accordance with an embodiment of the disclosed subject matter.

FIG. 2 is a side view of a medical bed and a component in connected configuration accordance with an embodiment of the disclosed subject matter.

FIG. 3 is a perspective view of a medical bed and a component in a disconnected configuration in accordance with an embodiment of the disclosed subject matter.

FIG. 4 is a side view of a medical bed and a component in a disconnected configuration in accordance with an embodiment of the disclosed subject matter.

FIG. 5 is a top view of a head bumper in accordance with an embodiment of the disclosed subject matter.

FIG. 6 is a top view of a foot bumper in accordance with an embodiment of the disclosed subject matter.

FIG. 7 is an exploded view of a head end of a medical bed and a headboard in a disconnected configuration in accordance with an embodiment of the disclosed subject matter.

FIG. 8 is an exploded view of a head end of a medical bed and a headboard in a disconnected configuration in accordance with an embodiment of the disclosed subject matter.

FIG. 9 is a perspective view of a first bracket and a first pin in accordance with an embodiment of the disclosed subject matter.

FIG. 10 is a side view of a first bracket and a first pin in accordance with an embodiment of the disclosed subject matter.

FIG. 11 is a front view of a first bracket and a first pin in accordance with an embodiment of the disclosed subject matter.

FIG. 12 is an exploded view of a foot end of a medical bed and a footboard in a disconnected configuration in accordance with an embodiment of the disclosed subject matter.

FIG. 13 is an exploded view of a foot end of a medical bed and a footboard in a disconnected configuration in accordance with an embodiment of the disclosed subject matter.

FIG. 14 is a cross-sectional view of a foot end of a medical bed and a footboard in a connected configuration in accordance with an embodiment of the disclosed subject matter.

FIG. 15 is a perspective view of a second bracket and a second pin in accordance with an embodiment of the disclosed subject matter.

FIG. 16 is a side view of a second bracket and a second pin in accordance with an embodiment of the disclosed subject matter.

FIG. 17 is a front view of a second bracket and a second pin in accordance with an embodiment of the disclosed subject matter.

### DETAILED DESCRIPTION

As required, detailed aspects of the disclosed subject matter are disclosed herein; however, it is to be understood that the disclosed aspects are merely exemplary of the disclosed subject matter, which may be embodied in various forms. Therefore, specific structural and functional details disclosed herein are not to be interpreted as limiting, but merely as a basis for the claims and as a representative basis for teaching one skilled in the art how to variously employ the disclosed technology in virtually any appropriately detailed structure.

Although the disclosed subject matter has been disclosed with reference to various embodiments, it is understood that equivalents may be employed, and substitutions made herein without departing from the scope of the disclosed subject matter as recited in the claims.

Certain terminology will be used in the following description, and are shown in the drawings, and will not be limiting. For example, up, down, front, back, right, and left refer to the disclosed subject matter as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

The disclosed subject matter will now be described with reference to the drawing figures, in which like reference numerals refer to like parts throughout. For purposes of clarity in illustrating the characteristics of the present disclosed subject matter, proportional relationships of the elements have not been maintained in the figures. In some cases, the sizes of certain small components have been exaggerated for illustration.

Although the subject matter has been disclosed with reference to various embodiments, it is understood that equivalents may be employed, and substitutions made herein without departing from the scope of the subject matter.

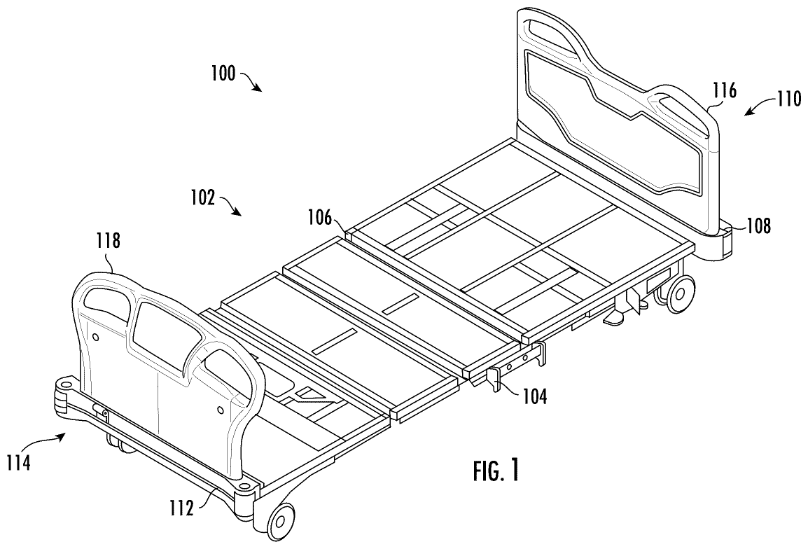

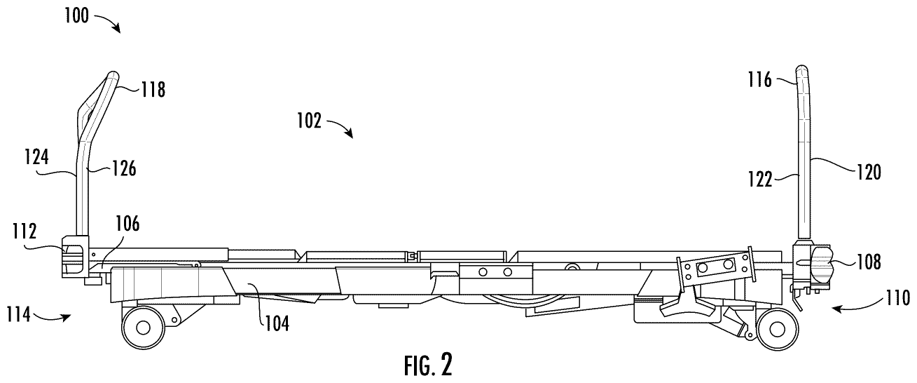

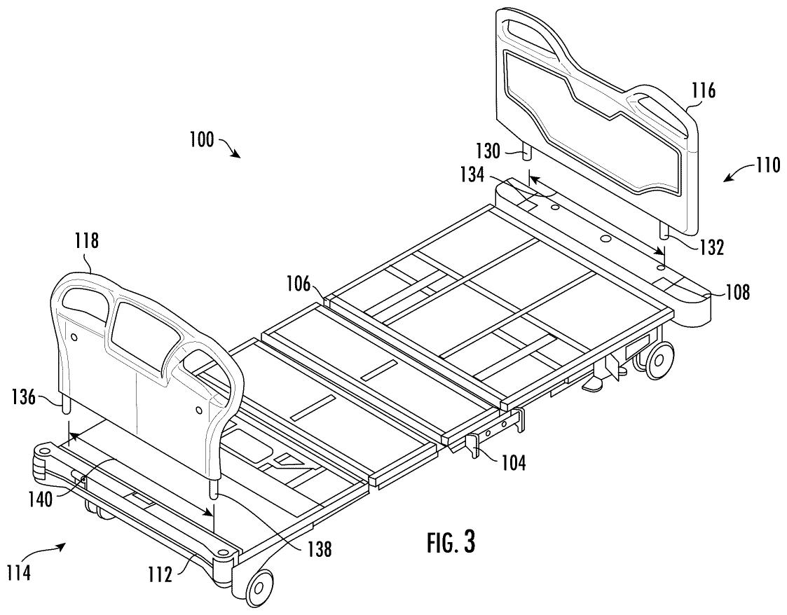

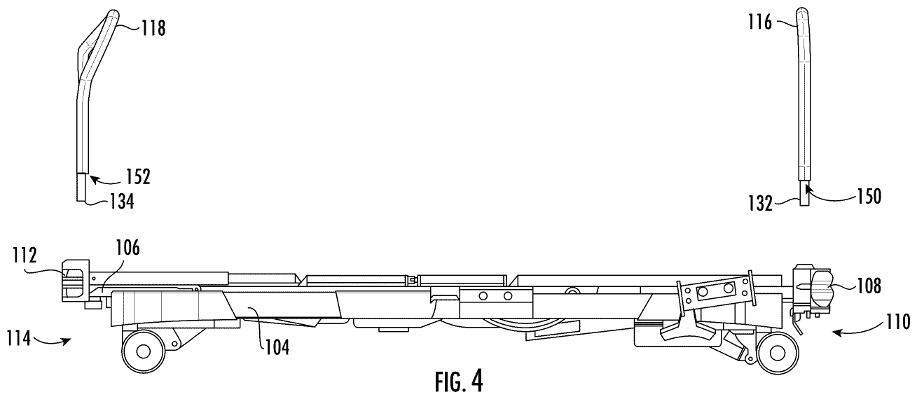

Referring to the drawings, FIGS. 1-6 show an embodiment of a connection system comprising a medical bed 100 having a patient support assembly 102 having a lower frame 104 and an upper frame 106 movable relative to the lower frame 104. The upper frame 106 may comprise a first component such as one of a head bumper 108 or a foot bumper 112. The medical bed 100 may comprise a second component such as one of a headboard 116 connected to the head bumper 108, a footboard 118 connected the foot bumper 112, and a side rail (not shown) connected to the patient support assembly 102. Each of the headboard 116, the footboard 118, and the side rail (not shown) extending upwardly and away from the upper frame 106. Reference to the head end 110 and the foot end 114 of the medical bed 100 is intended to provide an orientation reference and does not refer to any specific surface or structure.

In an embodiment of the disclosed subject matter, the headboard 116 may include an outer headboard surface 120 facing away from the footboard 118 and the inner headboard surface 122 facing towards the footboard 118. The footboard 118 may include an outer footboard surface 124 facing away from the headboard 116 and an inner footboard surface 126 facing towards the headboard 116.

The headboard 116 may comprise a first support post 130 and a second support post 132, each extending downwardly from the headboard 116 and configured to connect to the upper frame 106. The first support post 130 and the second support post 132 may be set apart from each other a first distance 134.

The footboard 118 may comprise a third support post 136 and a fourth support post 138, each of the third support post 136 and the fourth support post 138 extending downwardly from the footboard 118 and configured to connect to the upper frame 106. The third support post 136 and the fourth support post 138 may be set apart from each other a second distance 140.

In an embodiment, the head bumper 108 comprises a first receiver 142 configured to slidably receive and secure the first support post 130 when the first support post 130 is positioned within the first receiver 142. The head bumper 108 further comprises a second receiver 144 configured to slidably receive and secure the second support post 132 when the second support post 132 is positioned within second receiver 144. The first receiver 142 and the second receiver 144 are separated by the first distance 134 to align with the first support post 130 and second support post 132.

In an embodiment, the foot bumper 112 comprises a third receiver 146 configured to slidably receive and secure the third support post 136 when the third support post 136 is positioned within the third receiver 146. The foot bumper 112 further comprises a fourth receiver 148 configured to slidably receive and secure the fourth support post 138 when the fourth support post 138 is positioned within fourth receiver 148. The third receiver 146 and the fourth receiver 148 are separated by second distance 140 to align with the third support post 136 and the fourth support post 138.

In an embodiment, the headboard 116 comprises a first bottom surface 150 configured to abut the head bumper 108 when the first support post 130 and second support post 132 are inserted into the first receiver 142 and second receiver 144 respectively. Similarly, in an embodiment, the footboard 118 comprises a second bottom surface 152 configured to abut the foot bumper 112 when the third support post 136 and the fourth support post 138 are inserted into the third receiver 146 and fourth receiver 148 respectively.

In an embodiment, one or more of the support posts (130, 132, 136, 138) are cylindrical in shape and comprise a circular cross-sectional perimeter. It is to be understood that one or more of the support posts (130, 132, 136, 138) may comprise other cross-sectional perimeters, such as, by way of example, a square, a rectangle, a triangle, an oval, a polygon, or an irregular shape, as would be understood by one skilled in the art.

In an embodiment, the receivers (142, 144, 146, 148) comprise interior surfaces dimensioned to receive and secure the support posts (130, 132, 136, 138). The interior surfaces of the receivers are sized slightly larger than the exterior surface of the support posts (130, 132, 136, 138) to provide lateral support to the support posts (130, 132, 136, 138) when inserted into the receivers (142, 144, 146, 148).

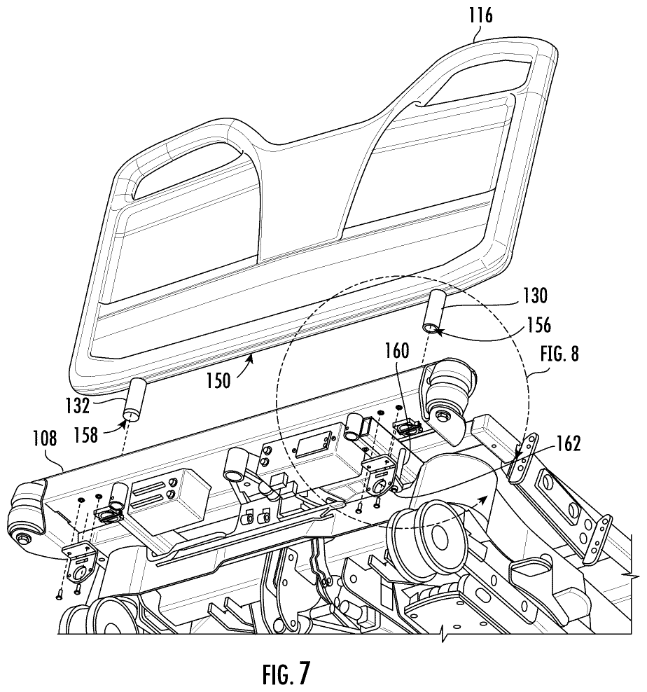

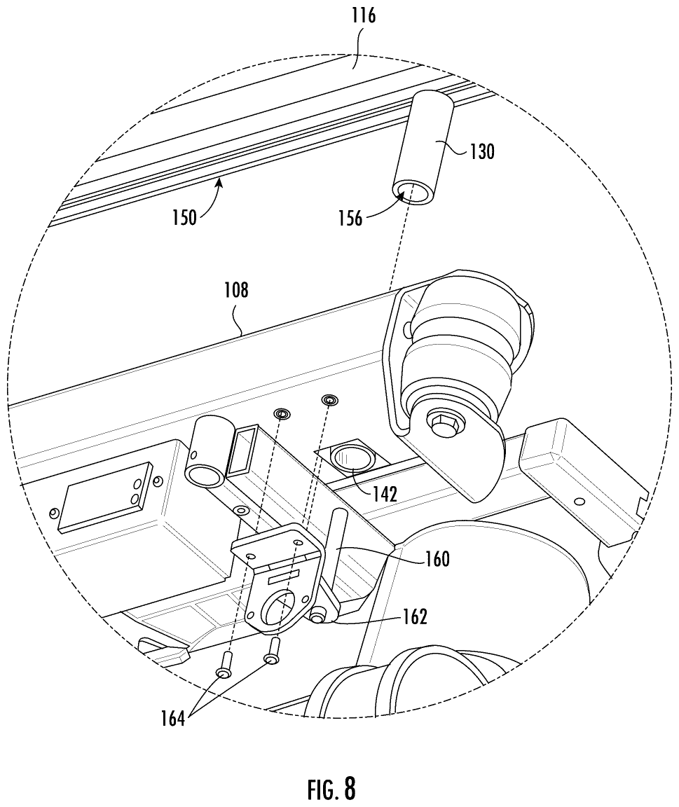

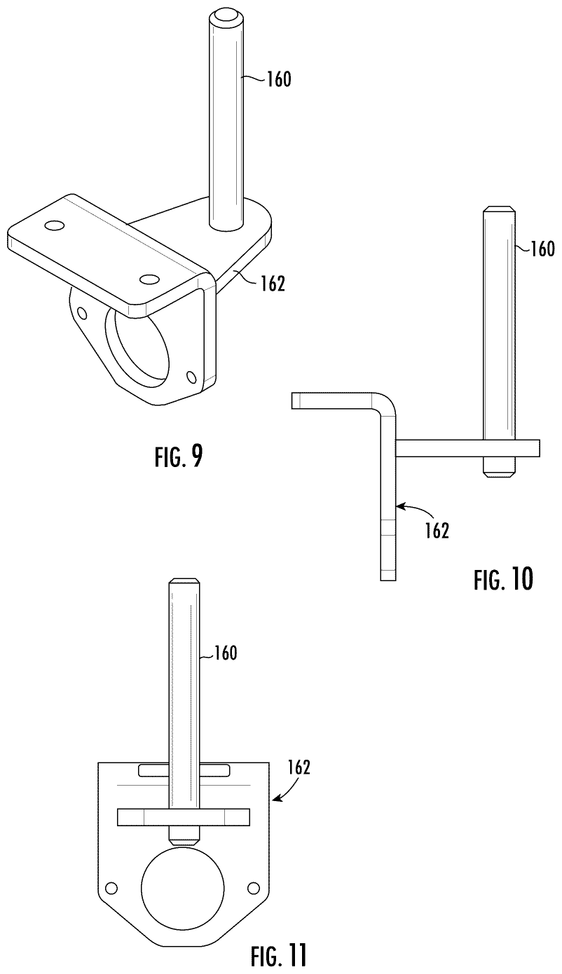

Referring to FIG. 5 and FIGS. 7-11, in an embodiment of the disclosed subject matter, the first support post 130 may comprise a first recess 156 extending axially upward into the first support post 130. In contrast, the second support post 132 may comprise a first bottom post surface 158 which does not extend upwardly into the second support post 132.

In an embodiment, the first receiver 142 comprises a first pin 160 centrally positioned along the axis of the first receiver 142. The first pin 160 may be supported by a first bracket 162 connected to the head bumper 108 via supporting hardware 164. The first pin 160 is shaped to be inserted within the first recess 156 when the first support post 130 is inserted into the first receiver 142. The first bottom post surface 158 prevents the second support post 132 from being inserted into the first receiver 142, thereby requiring the headboard 116 to be installed in a preferred orientation with the patient support assembly 102 whereby the inner headboard surface 122 faces foot end 114 and the outer headboard surface 120 faces the head end 110 when the first support post 130 and the first support post 130 are inserted within the first receiver 142 and the second receiver 144 respectively.

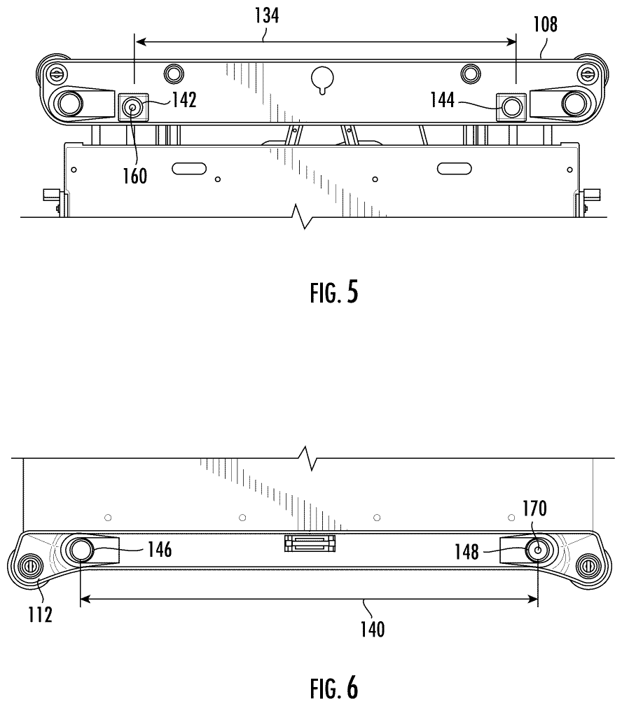

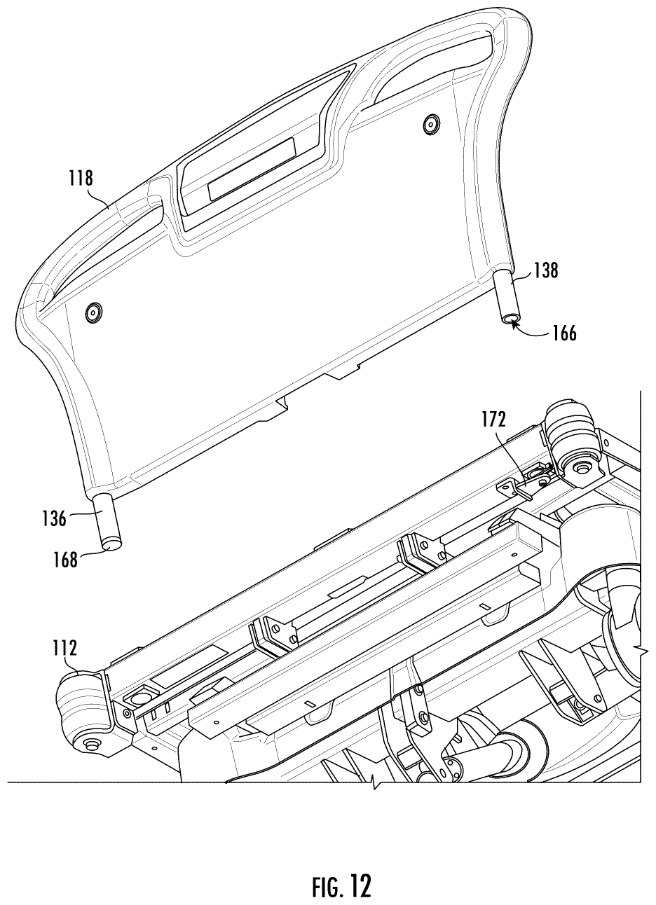

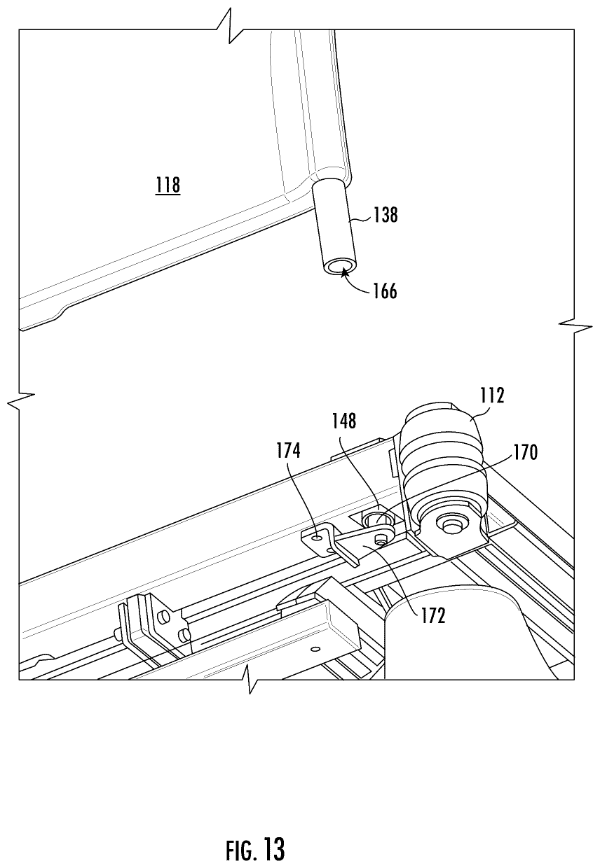

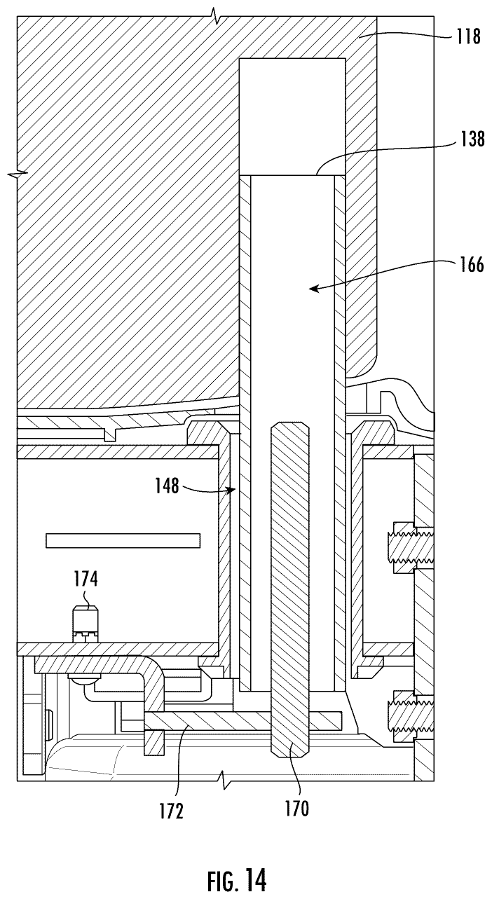

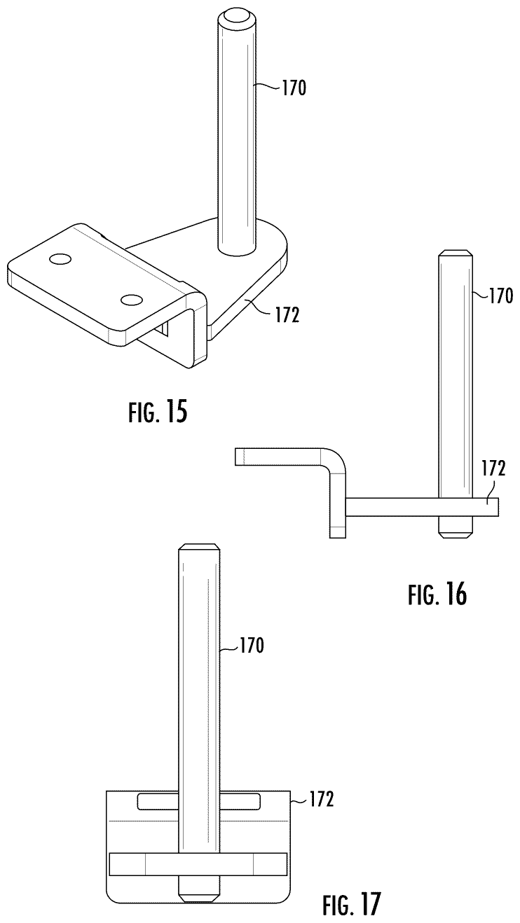

Referring to FIG. 6 and FIGS. 12-17, in an embodiment of the disclosed subject matter, the fourth support post 138 may comprise a second recess 166 extending axially upward into the fourth support post 138. In contrast, the third support post 136 may comprise a second bottom post surface 168 which does not extend upwardly into the third support post 136.

In an embodiment, the fourth receiver 148 comprises a second pin 170 centrally positioned along the axis of the fourth receiver 148. The second pin 170 may be supported by a second bracket 172 connected to the foot bumper 112 via supporting hardware 174. The second pin 170 is shaped to be inserted within the second recess 166 when the fourth support post 138 is inserted into the fourth receiver 148. The second bottom post surface 168 prevents the third support post 136 from being inserted into the fourth receiver 148, thereby requiring the footboard 118 to be installed in a preferred orientation with the patient support assembly 102 whereby the inner footboard surface 126 faces the head end 110 and the outer footboard surface 124 faces the foot end 114 when the third support post 136 and the fourth support post 138 are inserted within the third receiver 146 and the fourth receiver 148 respectively.

It is understood that other structural components, such as siderails, may be connected to the medical bed using a pair of support posts and a pair of receivers, wherein one of the receivers includes a pin centrally positioned along an axis of the receiver and one of the support posts includes one of a first recess and a second recess for at least partially accommodating the pin.

### Method of Use

In an embodiment, a method for connecting a component to a medical bed may comprise the steps of: (1) providing a medical bed having an upper frame, a first receiver, and a second receiver, wherein the first receiver includes a pin positioned along a central axis of the first receiver; (2) providing a component having a first support post and second support post, wherein the first support post includes a first recess extending into the first support post; (3) inserting the first support post into the first receiver, whereby the pin is inserted into the first recess; and (4) inserting the second support post into the second receiver, thereby connecting the component to the medical bed in a preferred orientation relative to the upper frame.

The components of the method for connecting a component to a medical bed may include one or more of a headboard, a footboard, and a side rail. It is to be understood that other components (structural, electrical, diagnostic, therapeutic, etc.) such may be connected to the medical bed using the above-described method.

The preferred orientation of the above-described method may be associated with an electrical connection between the medical bed and the component. The preferred orientation of the above-described method may be associated with accessibility to a surface of the component from a user position exterior to the perimeter of the medical bed.

Having described the disclosed subject matter, whish is claimed as new and desired to be secured by Letter Patents is:

1. A connection system comprising:
a first component having a first surface, the first component comprising:
a first receiver extending through the first surface, wherein the first receiver comprises a first pin aligned with a first central axis of the first receiver; and
a second receiver extending through the first surface; and
a second component having a second surface configured to abut the first surface, the second component comprising:
a first support post connected to and extending outwardly from the second surface, wherein the first support post comprises a first distal end and a first recess extending through the first distal end; and
a second support post connected to and extending outwardly from the second surface, wherein the first support post is approximately parallel to the second support post;
wherein the first receiver is configured to couple with the first support post when the first pin is at least partially inserted into the first recess, and
wherein the second receiver is configured to couple with the second support post, thereby connecting the first component to the second component.

2. The connection system of claim 1, wherein the first component comprises a patient support assembly of a medical bed.

3. The connection system of claim 1, wherein the second component comprises one of a headboard, a footboard, and a side rail.

4. The connection system of claim 1, wherein the first support post comprises a hollow cylinder.

5. The connection system of claim 4, wherein the first recess comprises a first cylindrical sleeve configured to couple with the hollow cylinder.

6. The connection system of claim 1, wherein the second support post comprises a solid cylinder.

7. The connection system of claim 6, wherein the second recess comprises a second cylindrical sleeve configured to couple with the second support post.

8. The connection system of claim 1, wherein the first surface is configured to at least partially abut the second surface.

9. The connection system of claim 1, wherein the first pin is connected to the first component via a bracket.

10. A connection system comprising:
a medical bed having an upper frame, the upper frame comprising:
a first receiver extending through the upper frame, wherein the first receiver comprises a first pin aligned with a first central axis of the first receiver; and
a second receiver extending through the upper frame; and
a second component having a second surface configured to abut the upper frame, the second component comprising:
a first support post connected to and extending outwardly from the second surface, wherein the first support post comprises a first distal end and a first recess extending through the first distal end; and
a second support post connected to and extending outwardly from the second surface, wherein the first support post is approximately parallel to the second support post;
wherein the first receiver is configured to couple with the first support post when the first pin is at least partially inserted into the first recess, and
wherein the second receiver is configured to couple with the second support post, thereby connecting the upper frame to the second component.

11. The connection system of claim 10, wherein the second component comprises one of a headboard, a footboard, and a side rail.

12. The connection system of claim 10, wherein the first support post comprises a hollow cylinder.

13. The connection system of claim 12, wherein the first recess comprises a first cylindrical sleeve configured to couple with the hollow cylinder.

14. The connection system of claim 10, wherein the second support post comprises a solid cylinder.

15. The connection system of claim 14, wherein the second receiver comprises a second cylindrical sleeve configured to couple with the second support post.

16. The connection system of claim 10, wherein the upper frame is configured to at least partially abut the second surface.

17. The connection system of claim 10, wherein the first pin is connected to the upper frame via a bracket.

18. A method for connecting a component to a medical bed comprising the steps of:
providing a medical bed having an upper frame, a first receiver, and a second receiver, wherein the first receiver includes a pin positioned along a central axis of the first receiver;
providing a component having a first support post and second support post, wherein the first support post comprises a first recess extending at least partially through first support post;
inserting the first support post at least partially into the first receiver, whereby the pin is at least partially inserted into the first recess; and
inserting the second support post at least partially into the second receiver, thereby connecting the component to the medical bed in a preferred orientation relative to the upper frame.

19. The method of claim 18, wherein the component comprises one of a headboard, a footboard, and a side rail.

20. The method of claim 18, wherein the first support post is approximately parallel with the second support post.
